(19) United States
(12) Patent Application Publication
(10) Pub. No.: US 2026/0097787 A1
(43) Pub. Date: Apr. 9, 2026

(54) UNIFIED MATCHING METHOD AND UNIFIED MATCHING SYSTEM FOR MULTI-PEDESTRIAN TRACKING

(71) Applicant: HL Klemove Corp., Incheon (KR)

(72) Inventors: Hyeonchul JUNG, Incheon (KR); Seokjun KANG, Incheon (KR); Takgen KIM, Incheon (KR); Hyeongki KIM, Incheon (KR)

(73) Assignee: HL Klemove Corp., Incheon (KR)

(21) Appl. No.: 19/347,282

(22) Filed: Oct. 1, 2025

(30) Foreign Application Priority Data
Oct. 7, 2024 (KR) 10-2024-0135353

(51) Int. Cl. B60W 60/00; G06T 7/277; G06V 10/74

(52) U.S. Cl. CPC B60W 60/001; G06T 7/277; G06V 10/74; B60W 2554/40

(57) ABSTRACT

A unified matching method for multi-pedestrian tracking according to an embodiment of the present disclosure comprises: dividing road environment images collected from at least one sensor into frames and detecting an object in an N-th frame; calculating a matching cost matrix between the detected object and tracked objects detected in a previous frame of the road environment images; matching the detected object with one of the tracked objects using the matching cost matrix; generating a matching threshold value based on a confidence score of the detected object; updating the matched tracked object using the detected object when a matching cost between the matched tracked object and the detected object is smaller than the matching threshold value; and controlling a vehicle based on the updated tracked object.

### CROSS-REFERENCE TO RELATED APPLICATION

This application claims the benefit of and priority to Korean Patent Application No. 10-2024-0135353 filed on Oct. 7, 2024, the entire disclosures of which are incorporated herein by reference.

### TECHNICAL FIELD

The present disclosure relates to a unified matching method and a unified matching system for multi-pedestrian tracking. More particularly, the present disclosure relates to a unified matching method and a unified matching system for multi-pedestrian tracking using matching threshold values dynamically adjusted based on confidence scores of detected objects.

### BACKGROUND

Recently, in autonomous driving system technology, the importance of computer vision technology required to recognize and interpret the surrounding environment has been significantly highlighted. In particular, a technology for identifying the position or movement of pedestrians in proximity to a vehicle is one of the key factors in ensuring the safety of both humans and autonomous vehicles.

Among such technologies, a Multi-Pedestrian Tracking (MPT) system provides the capability to simultaneously recognize and track multiple pedestrians in a complex road environment.

In order to improve the performance of an MPT system, various algorithms and mechanisms have been developed. In particular, with the advancement of deep learning-based detectors, one of the most widely used approaches at present is the tracking-by-detection (TBD) mechanism.

Recently, most studies have employed a cascade matching method in which matching steps are divided according to the confidence scores of detected objects. However, this may cause a possibility that matching of a low-confidence detected object is ignored even when it actually corresponds to an important pedestrian.

Accordingly, there is a need for a matching method and a matching system for multi-pedestrian tracking that solve such problems of cascade matching and enable more robust trajectory generation of tracked objects.

### SUMMARY

The present disclosure is intended to solve problems of the prior art described above, and an object of the present disclosure is to provide a unified matching method and a unified matching system for multi-pedestrian tracking that can improve tracking performance by preserving the matching of low-confidence detected objects corresponding to true positives and suppressing the matching of low-confidence detected objects corresponding to false positives, even when both high-confidence detected objects and low-confidence detected objects are used in a unified matching step.

In addition, the present disclosure is intended to provide a unified matching method and a unified matching system for multi-pedestrian tracking that can be implemented with a simpler algorithm compared to cascade matching.

However, the technical problems to be achieved by the embodiments of the present disclosure are not limited to the technical problems described above, and other technical problems may also exist.

As a technical means for achieving the above technical problem, a unified matching method for multi-pedestrian tracking according to an embodiment of the present disclosure comprises: dividing road environment images collected from at least one sensor into frames and detecting an object in an N-th frame; calculating a matching cost matrix between the detected object and tracked objects detected in a previous frame of the road environment images; matching the detected object with one of the tracked objects using the matching cost matrix; generating a matching threshold value based on a confidence score of the detected object; updating the matched tracked object using the detected object when a matching cost between the matched tracked object and the detected object is smaller than the matching threshold value; and controlling a vehicle based on the updated tracked object.

Further, the generating the matching threshold value may comprise: determining the confidence score of the detected object; and generating the matching threshold value by multiplying the confidence score with a predetermined threshold constant value.

Further, the generating of the matching threshold value may further comprise generating a matching threshold matrix including matching threshold values, and if the number of the tracked objects is n and the number of detected objects is m, a dimension of the matching threshold matrix is (n, m).

Further, the calculating of the matching cost matrix may comprise: predicting expected positions of the tracked objects in the N-th frame by using a Kalman filter; and calculating the matching cost matrix based on Intersection over Union (IoU) values between bounding boxes of the tracked objects at the expected positions and a bounding box of the detected object.

Further, the calculating of the matching cost matrix may further comprise: calculating embedding vectors of the tracked objects by inputting regions of the bounding boxes of the tracked objects into a feature extractor; calculating an embedding vector of the detected object by inputting a region of the bounding box of the detected object into the feature extractor; and calculating the matching cost matrix based on cosine distances between the embedding vectors of the tracked objects and the embedding vector of the detected object.

Further, the matching of the detected object with one of the tracked objects may comprise: performing one-to-one matching between the detected object and the tracked objects by using a Hungarian algorithm.

Further, if the confidence score of the detected object is greater than or equal to a predetermined threshold value and the detected object is not matched with any one of the tracked objects, a new tracked object may be generated by using the detected object.

Further, the new tracked object may be deleted when the new tracked object is not matched with an object detected in a subsequent frame.

Further, the new tracked object may become a confirmed tracked object when the new tracked object is subsequently matched for at least a predetermined number of consecutive frames, and the confirmed tracked object may not be deleted even if it is not matched with an object detected in a subsequent frame.

A unified matching system for multi-pedestrian tracking, according to embodiments of the present disclosure comprises: a controller comprising at least one processor configured to control a vehicle based on information on road environment images of a road on which the vehicle travels, wherein the controller is configured to: divide the road environment images into frames; detect an object in an N-th frame; calculate a matching cost matrix between the detected object and tracked objects detected in a previous frame of the road environment images; match the detected object with one of the tracked objects by using the matching cost matrix; generate a matching threshold value based on a confidence score of the detected object; update the matched tracked object using the detected object when a matching cost between the matched tracked object and the detected object is smaller than the matching threshold value; and control the vehicle based on the updated tracked object.

Further, the controller may be connected to a braking apparatus configured to control a longitudinal driving of the vehicle and a steering apparatus configured to control a lateral driving of the vehicle, and the controller is configured to control at least one of the braking apparatus and the steering apparatus based on the updated tracked object.

Further, the information on the road environment images may be collected by a sensor, and the sensor comprises at least one of a front camera and a rear camera.

Further, the controller may be configured to determine the confidence score of the detected object and generate the matching threshold value by multiplying the confidence score with a predetermined threshold constant value.

Further, the controller may be configured to generate a matching threshold matrix including matching threshold values, and if the number of tracked objects is n and the number of detected objects is m, a dimension of the matching threshold matrix may be (n, m).

Further, the controller may be configured to predict expected positions of the tracked objects in the N-th frame by using a Kalman filter, and calculate the matching cost matrix based on Intersection over Union (IoU) values between bounding boxes of the tracked objects at the expected positions and a bounding box of the detected object.

Further, the controller may be configured to: calculate embedding vectors of the tracked objects by inputting regions of the bounding boxes of the tracked objects into a feature extractor; calculate an embedding vector of the detected object by inputting a region of the bounding box of the detected object into the feature extractor; and calculate the matching cost matrix based on cosine distances between the embedding vectors of the tracked objects and the embedding vector of the detected object.

Further, the controller may be configured to perform one-to-one matching between the detected object and the tracked objects by using a Hungarian algorithm.

Further, the controller may be configured to generate a new tracked object using the detected object when the confidence score of the detected object is greater than or equal to a predetermined threshold and the detected object is not matched with any one of the tracked objects.

Further, the controller may be configured to delete the new tracked object when the new tracked object is not matched with an object detected in a subsequent frame, determine the new tracked object as a confirmed tracked object when the new tracked object is subsequently matched for at least a predetermined number of consecutive frames, and the confirmed tracked object is not deleted even if the confirmed tracked object is not matched with an object detected in a subsequent frame.

Meanwhile, in a non-transitory computer-readable recording medium that records a program for executing a unified matching method for multi-pedestrian tracking according to an embodiment of the present disclosure on a computer, the method comprises: dividing road environment images collected from at least one sensor into frames and detecting an object in an N-th frame; calculating a matching cost matrix between the detected object and tracked objects detected in a previous frame of the road environment images; matching the detected object with one of the tracked objects using the matching cost matrix; generating a matching threshold value based on a confidence score of the detected object; updating the matched tracked object using the detected object when a matching cost between the matched tracked object and the detected object is smaller than the matching threshold value; and controlling a vehicle based on the updated tracked object.

The above-described means for solving the problem is only exemplary and should not be construed as limiting the present disclosure. In addition to the exemplary embodiments described above, additional embodiments may exist in the drawings and the following detailed description.

According to the problem-solving means of the present disclosure as described above, it is possible to provide a unified matching method and a unified matching system for multi-pedestrian tracking that can maintain object tracking capability even when phenomena that make object tracking difficult, such as crossing or occlusion between pedestrians, occur.

In addition, according to the problem-solving means of the present disclosure, it is possible to provide a unified matching method and a unified matching system for multi-pedestrian tracking that have a simpler algorithm than the conventional cascade matching method while exhibiting superior generalization performance.

However, the effects obtainable from the present disclosure are not limited to the effects described above, and other effects may exist.

### BRIEF DESCRIPTION OF THE DRAWINGS

FIG. 1 is a control flowchart showing a unified matching method for multi-pedestrian tracking according to an embodiment of the present disclosure.

FIG. 2 is a control flowchart showing in more detail the object detection step in the unified matching method for multi-pedestrian tracking according to the embodiment of the present disclosure.

FIG. 3 is a control flowchart showing in more detail the step of calculating a matching cost matrix in the unified matching method for multi-pedestrian tracking according to the embodiment of the present disclosure.

FIG. 4 is a control flowchart showing in more detail the step of generating a matching threshold value in the unified matching method for multi-pedestrian tracking according to the embodiment of the present disclosure.

FIG. 5 is a diagram showing an algorithm for implementing the unified matching method for multi-pedestrian tracking according to the embodiment of the present disclosure.

FIG. 6 is a control configuration diagram schematically showing the configuration of a unified matching system for multi-pedestrian tracking according to embodiments of the present disclosure.

### DETAILED DESCRIPTION

Hereinafter, with reference to the accompanying drawings, embodiments of the present disclosure will be described in detail so that those skilled in the art can easily practice the embodiments. However, the present disclosure may be implemented in many different forms and is not limited to the embodiments described herein. In addition, in order to clearly describe the present disclosure in the drawings, parts irrelevant to the description are omitted, and similar reference numerals are attached to similar parts throughout the present disclosure.

Throughout the present disclosure, if a part is said to be “connected” to another part, it is not only “directly connected”, but also “electrically connected” with another element in between, including cases where they are “indirectly connected”.

Throughout the present disclosure, if one member is said to be located “on”, “above”, “under”, or “below” the other member, this includes not only the case of being in contact with the other member, but also the case that another member is positioned between the two members.

Throughout the present disclosure, if a part “includes” a certain component, it does not mean excluding other components, and it does mean that it may further include other components, unless otherwise stated.

The present disclosure relates to a unified matching method and system for multi-pedestrian tracking that can increase the accuracy of matching between detected objects and tracked objects and improve tracking performance by dynamically adjusting matching threshold values based on confidence scores of detected objects.

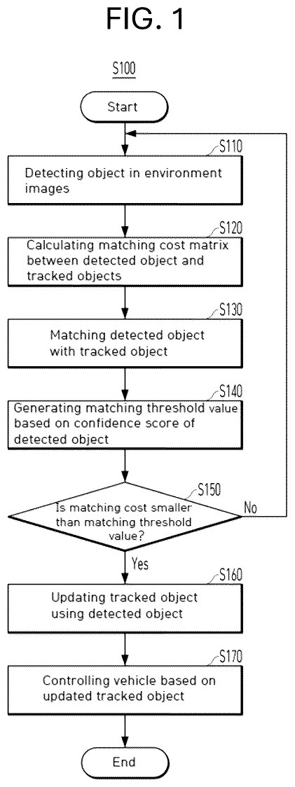

FIG. 1 is a control flowchart showing a unified matching method for multi-pedestrian tracking according to an embodiment of the present disclosure.

Referring to FIG. 1, a unified matching method for multi-pedestrian tracking S100 according to an embodiment of the present disclosure may include an object detection step of dividing road environment images collected from at least one sensor into frames and detecting an object in an N-th frame S110.

Here, the road environment images (video) may be images of a road environment on which a vehicle travels, and may be a video collected through sensors such as a front camera and/or a rear camera installed at the vehicle. The road environment video may include objects such as pedestrians, surrounding objects, and other vehicles.

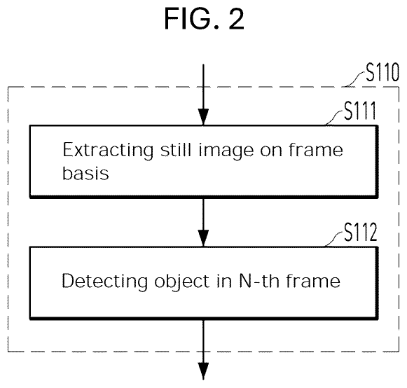

The road environment images may be divided into frames, and an object may be detected in each still image of the frames in a form such as a bounding box. Here, a plurality of objects may be detected. For example, m objects may be detected in an N-th frame of the road environment images. A method of detecting an object in the road environment images will be described in more detail with reference to FIG. 2.

Subsequently, a step of calculating a matching cost matrix between the detected object and tracked objects detected in a previous frame of the road environment images S120 may be performed.

Here, the detected object is an object detected in an N-th frame of the road environment images, and the tracked objects may be objects detected in previous frames including an (N−1)-th frame of the road environment images.

The matching cost matrix is a matrix used for matching the detected object with one of the tracked objects, and the lower the cost, the higher the probability that the two objects are the same object. The dimension of the matching cost matrix may be (n, m) if the number of the tracked objects is n and the number of the detected objects is m.

In relation to a method of calculating the matching cost matrix, the matching cost matrix may be calculated, after predicting expected positions of tracked objects in an N-th frame by using a Kalman filter, based on Intersection over Union (IoU) values between bounding boxes of the tracked objects at the expected positions and a bounding box of the detected object.

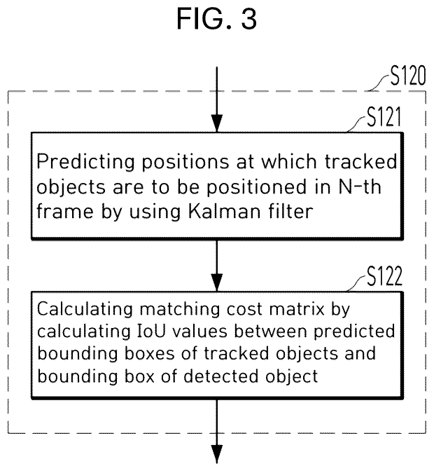

In addition, embedding vectors may be calculated by inputting regions of the bounding boxes of the tracked objects into a feature extractor and calculating an embedding vector by inputting a region of the bounding box of the detected object into the feature extractor, and the matching cost matrix may then be calculated based on cosine distances between the embedding vectors of the tracked objects and the embedding vector of the detected object. A method of calculating the matching cost matrix will be described in more detail with reference to FIG. 3.

Next, a step of performing one-to-one matching between the detected object and the tracked objects using the matching cost matrix S130 may be performed. The detected object and one of the tracked objects may be matched by using the matching cost matrix calculated in step S120. For example, an optimal matching that minimizes the matching cost may be determined by using a Hungarian algorithm.

Subsequently, a step of generating a matching threshold value based on a confidence score of the detected object S140 may be performed.

Here, the confidence score of a detected object represents a degree to which it can be assured that the detected object actually exists. For example, the confidence score of the detected object may become higher as the detected object appears larger and clearer, as the object is fully visible without being occluded, and as a bounding box of the detected object coincides with a bounding box predicted by a Kalman filter. Such a confidence score of the detected object may be determined, for example, by using a confidence score in a deep learning detection model, and may be expressed as a value between 0 and 1.

Meanwhile, the matching threshold value is a reference value for determining whether a detected object and a tracked object are regarded as the same object. For example, when a matching cost between a detected object and a tracked object is smaller than the matching threshold value, the detected object and the tracked object may be regarded as the same object.

In the unified matching method for multi-pedestrian tracking according to the embodiment of the present disclosure, a matching threshold value may be dynamically adjusted according to the confidence score. For example, if the confidence score of a detected object is high, the matching threshold value may be set large, and if the confidence score of a detected object is low, the matching threshold value may be set small.

Through this, in the matching step, a penalty may be applied to a low-confidence detected object so that it is required to be matched with a tracked object at a lower cost than a high-confidence detected object. In general, false positive (FP) detected objects usually have lower confidence scores and are matched with tracked objects at higher costs compared to true positive (TP) objects. Therefore, by dynamically adjusting the matching threshold value based on the confidence score, even when both high-confidence detected objects and low-confidence detected objects are used together in unified matching, matching of low-confidence detected objects corresponding to false positives can be suppressed while matching of low-confidence detected objects corresponding to true positives can be preserved.

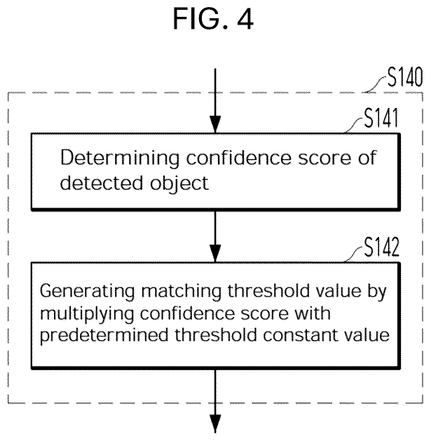

A specific method of generating the matching threshold value will be described in more detail with reference to FIG. 4.

Subsequently, a step of determining whether a matching cost between the matched the tracked object and detected object is smaller than the matching threshold value S150 may be performed.

When it is determined in step S150 that the matching cost is smaller than the matching threshold value (“Yes” of S150), a step of updating the tracked object by using the matched detected object S160 may be performed. On the other hand, when the matching cost between the matched detected object and the tracked object is greater than or equal to the matching threshold value (“No” of S150), the tracked object may not be updated with the detected object.

Meanwhile, when a detected object is not matched with any tracked object but has a confidence score greater than or equal to a predetermined threshold value (for example, 0.6), the detected object may be used to initialize a new tracked object.

An initialized tracked object becomes a confirmed tracked object when it is subsequently matched for at least a predetermined number of consecutive frames (for example, three consecutive frames). Once it becomes a confirmed tracked object, it may be maintained for a predetermined number of frames (for example, thirty frames) even if it is not matched with a detected object in subsequent frames. On the other hand, if the initialized tracked object is not matched with a detected object in the subsequent frame before becoming a confirmed tracked object, the initialized tracked object may be deleted.

According to the unified matching method for multi-pedestrian tracking according to the embodiment of the present disclosure, by matching detected objects and tracked objects through a single matching step, it is possible to solve the problems of the cascade matching method in which matching is divided into multiple steps. For example, in a cascade matching method, matching is divided into two steps such that high-confidence detected objects are preferentially matched with tracked objects in a first step, and then, in a second step, unmatched tracked objects are matched with low-confidence detected objects. Therefore, high-confidence detected objects are always matched before low-confidence detected objects. As a result, even if a low-confidence detected object is actually closer to a pedestrian than a high-confidence detected object, the low-confidence detected object may be ignored. In contrast, according to the unified matching method for multi-pedestrian tracking of the embodiment of the present disclosure, by matching detected objects and tracked objects through a single matching step, the problem of ignoring low-confidence detected objects can be solved.

Furthermore, according to the unified matching method for multi-pedestrian tracking of an embodiment of the present disclosure, by dynamically adjusting the matching threshold value according to the confidence score of a detected object, a low-confidence detected object is allowed to be matched only with a tracked object having a lower matching cost than that of a high-confidence detected object. Accordingly, even if both high-confidence detected objects and low-confidence detected objects are used together in a single matching step, the matching of low-confidence detected objects corresponding to true positive can be preserved and the matching of low-confidence detected objects corresponding to false positive can be suppressed, thereby improving tracking performance.

Table 1 below is a table comparing the performance of a cascade matching method with the performance of the unified matching method according to the embodiment of the present disclosure. Result values showing better performance in the unified matching method according to the embodiment of the present disclosure are indicated in bold.

TABLE 1

| Method | HOTA ↑ | DetA ↑ | AssA ↑ | LocA ↑ | MOTA ↑ | MOTP ↑ | IDF1 ↑ |
|---|---|---|---|---|---|---|---|
| Cascade matching | 69.02 | 66.90 | 71.84 | 86.08 | 78.10 | 84.32 | 81.87 |
| (ByteTrack) | | | | | | | |
| Unified matching | 69.45 | 66.85 | 72.75 | 86.19 | 78.00 | 84.33 | 82.50 |
| (Embodiment) | | | | | | | |

Table 1 represents values comparing tracking performances on the MOT17 validation set by replacing only the matching method in a multi-pedestrian tracking (MPT) model, that is, replacing the cascade matching method provided by ByteTrack with the unified matching method according to the embodiment of the present disclosure.

As performance evaluation metrics, three main indicators, HOTA, CLEAR, and Identity, were used. HOTA consists of Detection Accuracy (DetA), Association Accuracy (AssA), and Localization Accuracy (LocA), and is used as the primary metric due to its advantage of considering both detection performance and trajectory generation performance. CLEAR is the most widely used evaluation metric and includes Multi-Object Tracking Accuracy (MOTA) and Multi-Object Tracking Precision (MOTP). While CLEAR mainly focuses on detection performance, Identity focuses on how consistently tracking trajectories are generated without ID switch phenomena and includes the IDF1 score. Here, the above metrics were calculated using the TrackEval framework.

As shown in the performance comparison results between the cascade matching method and the unified matching method according to the embodiment of the present disclosure, the unified matching method according to the embodiment of the present disclosure exhibited significant performance improvements of 0.4 and 0.6 in HOTA and IDF1, respectively. HOTA is a value that integrates DetA, AssA, and LocA metrics, among which improvements in LocA and AssA corresponding to matching accuracy are particularly notable. This demonstrates that, by using the unified matching method according to the embodiment of the present disclosure, tracked objects were more matched with detected objects corresponding to ground truth (GT). In other words, processing matching in a single unified matching step without explicitly dividing matching steps based on detection confidence scores shows higher generalization performance.

Meanwhile, the implementation details of the experiment for the above performance comparison are as follows. First, MOT17, which was used as the dataset, is one of the most widely used benchmark datasets for evaluating MPT systems and is particularly suitable for evaluating the generalization performance of MPT algorithms since it frequently includes phenomena that make tracking difficult, such as pedestrian occlusion and illumination changes. MOT17 is divided into seven training sets and seven evaluation sets, and, in the same manner as ByteTrack, we created validation sets by splitting the training sets in half and used them in the experiment.

In the experiment, YOLOX was used as the detector, and the weights trained by ByteTrack were used. After filtering with Non-Maximum Suppression (NMS) using an IoU threshold of 0.7, only detected objects with a confidence score of 0.1 or higher were used. For Camera Motion Compensation (CMC), a sparse optical flow algorithm implemented by OpenCV was used in the same manner as DeepOCSORT. With respect to tracked object management, the detection confidence score threshold for initializing a tracked object was 0.6, an initialized tracked object became a confirmed tracked object when matched for three consecutive frames, and was deleted immediately if not matched. A confirmed tracked object could be maintained for 30 frames even without being matched. For the cascade matching proposed by ByteTrack, the IoU threshold used in the first step was 0.8, and the IoU threshold used in the second step was 0.5. In the unified matching method according to the embodiment of the present disclosure, the IoU threshold was 1.0. In consideration of use in autonomous driving and real-time operating feasibility, the matching cost matrix was calculated based on IoU without using a separate feature extractor. All systems were implemented through PyTorch and executed on a desktop with an Intel Core i9-10900K@3.7 GHZ and an NVIDIA Geforce RTX 3090.

FIG. 2 is a control flowchart showing in more detail the object detection step in the unified matching method for multi-pedestrian tracking according to the embodiment of the present disclosure.

Referring to FIG. 2, the object detection step S110 may include a step of extracting still images on a frame basis S111. For example, road environment images captured through a camera mounted on a vehicle may be converted into still images on a frame basis.

Subsequently, a step of detecting an object in an N-th frame S112 may be performed. Each frame of the road environment images may include an object such as a pedestrian, an object, or other vehicle, and the object may be detected in the form of a bounding box.

A bounding box represents the position of an object with a rectangular box and may include, for example, information on the position and size of the object. In addition, an ID may be assigned to each detected object, and the same object may maintain the same ID even when frames change.

FIG. 3 is a control flowchart showing in more detail the step of calculating a matching cost matrix in the unified matching method for multi-pedestrian tracking according to the embodiment of the present disclosure.

Referring to FIG. 3, the step of calculating a matching cost matrix S120 may include a step of predicting positions at which tracked objects are to be positioned in an N-th frame by using a Kalman filter S121.

A Kalman filter is an algorithm that predicts a next state based on a previous state, and in multi-pedestrian tracking, it may be used to predict the movement of an object and to stably maintain tracking. For example, the Kalman filter may predict the position of an object in the next frame by considering the previous velocity of the object.

Subsequently, a step of calculating a matching cost matrix S122 may be performed by calculating IoU values between predicted bounding boxes of the tracked objects and a bounding box of the detected object.

Here, IoU (Intersection over Union) is a value that measures how much two bounding boxes overlap, and the higher the IoU value, the higher the likelihood that the two boxes correspond to the same object. In step S122, the IoU values between each of the bounding boxes of tracked objects predicted in step S121 and the bounding box of a detected object in an N-th frame may be calculated.

Meanwhile, since a higher IoU value corresponds to a lower matching cost, the matching cost value may be calculated, for example, as 1−IoU. The matching cost matrix between tracked objects and detected objects represents, in a matrix form, the matching cost values of tracked object-detected object pairs.

FIG. 4 is a control flowchart showing in more detail the step of generating a matching threshold value in the unified matching method for multi-pedestrian tracking according to the embodiment of the present disclosure.

Referring to FIG. 4, the step of generating a matching threshold value S140 may include a step of determining a confidence score of a detected object S141.

The confidence score is a value indicating the probability that a detected object actually exists, and if the confidence score is low, the likelihood of a false detection increases. For example, the confidence score may become higher as the boundary of the object is more distinct from the background, as the object is sufficiently large within a frame, and as the object is fully visible without being occluded.

Subsequently, a step of generating a matching threshold value by multiplying a confidence score of a detected object by a predetermined threshold constant value S142 may be performed.

Here, the threshold constant value is a fixed value (scalar value) and may be, for example, 1, but is not limited thereto. According to the embodiment of the present disclosure, by generating a matching threshold value through multiplying a confidence score of a detected object by the threshold constant value, it is possible to generate a matching threshold value for each detected object and dynamically adjust a matching threshold value based on a confidence score.

Meanwhile, with respect to a plurality of tracked objects and detected objects, a matching threshold matrix including respective matching threshold values for tracked object-detected object pairs may be calculated.

For example, given a set Tₙ₋₁ of objects detected in an (n−1)-th frame and a set Dₙ of objects detected in an n-th frame, let tᵢ denote a tracked object corresponding to an i-th index of Tₙ₋₁, and let dⱼ denote a detected object corresponding to a j-th index of Dₙ. In this case, an (i,j)-th element of a matching threshold matrix M may be defined as follows.

$${M}_{ij} = m * {c}_{j} \qquad [ Equation 1 ]$$

Here, c, corresponds to a confidence score of dⱼ. When the length of Tₙ₋₁ is l₁ and the length of Dₙ is l₂, the dimension of the matching threshold matrix M is (l₁, l₂). By using such a matching threshold matrix, the matching threshold value can be dynamically adjusted based on the confidence score of each detected object.

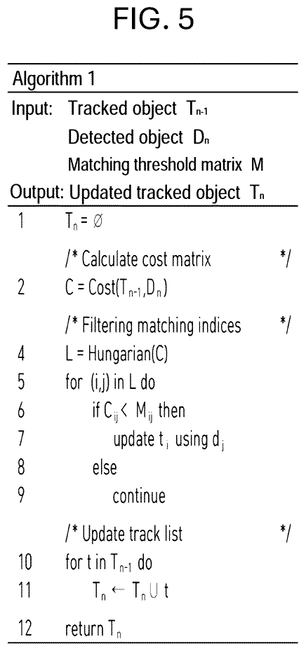

FIG. 5 is a diagram showing an algorithm for implementing the unified matching method for multi-pedestrian tracking according to the embodiment of the present disclosure.

Referring to FIG. 5, when Tₙ₋₁, Dₙ and M are given, a process of obtaining an updated set T of tracked objects is as follows. First, a matching cost matrix C between Tₙ₋₁ and Dₙ may be calculated. In this process, a cost matrix based on IoU, which represents the degree of overlap of bounding boxes, may be used. When a separate feature extractor is additionally used, a region corresponding to a bounding box may be input into the feature extractor to obtain an embedding vector, and cosine distances between embedding vectors may also be utilized. Based on the cost matrix C, a matching index matrix L may be obtained through a Hungarian algorithm, where L consists of index pairs of tracked objects and detected objects. For each index pair, only when a matching cost Cᵢⱼ between the tracked object and the detected object is smaller than a matching threshold value Mᵢⱼ, the tracked object tᵢ may be updated by using the detected object dⱼ through a Kalman filter.

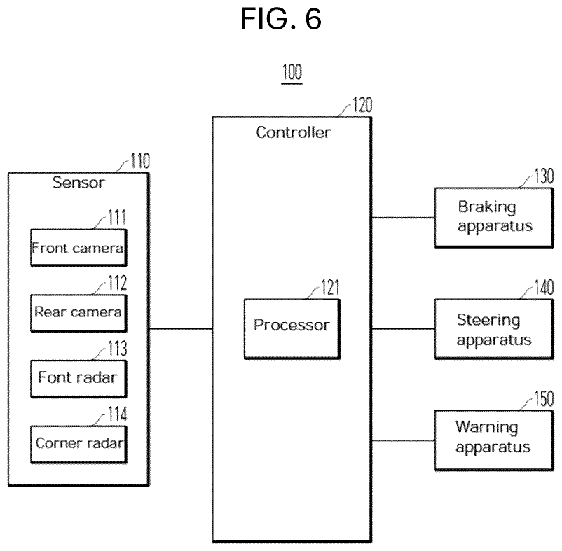

FIG. 6 is a control configuration diagram schematically showing the configuration of a unified matching system for multi-pedestrian tracking according to embodiments of the present disclosure.

Referring to FIG. 6, a unified matching system 100 for multi-pedestrian tracking according to an embodiment of the present disclosure may include a sensor 110 configured to collect information on road environment images of a road on which a vehicle travels, and a controller 120 including at least one processor 121 configured to control the vehicle based on the information collected from the sensor 110.

The controller 120 may be configured to: divide road environment images into frames; detect an object in an N-th frame; calculate a matching cost matrix between the detected object and tracked objects detected in a previous frame of the road environment images; match the detected object with one of the tracked objects using the matching cost matrix; generate a matching threshold value based on a confidence score of the detected object; update the matched tracked object by using the detected object when a matching cost between the matched tracked object and the detected object is smaller than the matching threshold value; and control the vehicle based on the updated tracked object.

The sensor 110 may be mounted on the vehicle and collect surrounding road environment images while the vehicle is traveling. For example, the sensor 110 may include at least one of a front camera 111 and a rear camera 112. In addition, the sensor 110 may further include at least one of a front radar 113 and a corner radar 114. However, the present disclosure is not limited thereto, and other types of sensors for sensing the surroundings of the vehicle, such as an ultrasonic sensor or a LIDAR sensor may be included.

The processor 121 of the controller 120 may control overall operations of each component of the system 100. The processor 121 may include a CPU (Central Processing Unit), an MPU (Micro Processor Unit), an MCU (Micro Controller Unit), a GPU (Graphics Processing Unit), or any type of processor well known in the art to which the present disclosure pertains. In addition, the processor 121 may perform operations on at least one application or program for executing the methods according to embodiments of the present disclosure.

In addition, the controller 120 may be connected to a braking apparatus 130 configured to control longitudinal driving of the vehicle and a steering apparatus 140 configured to control lateral driving of the vehicle. The controller 120 may control the vehicle by controlling at least one of the braking apparatus 130 and the steering apparatus 140 based on the updated tracked object.

In addition, the controller 120 may be connected to a warning apparatus 150 configured to provide an alarm for warning a driver or passenger of the vehicle of a risk of sudden braking or collision. The warning apparatus 150 may include at least one of a visual alarm device, an auditory alarm device, and a haptic alarm device, and accordingly, a driver or passenger may be warned of, for example, a risk of collision with a detected object through a visual alarm, an auditory alarm, and/or a haptic alarm.

Meanwhile, since the specific unified matching method for multi-pedestrian tracking according to the embodiment of the present disclosure performed by the controller 120 has already been described in detail above, a detailed description thereof will be omitted here.

The disclosed embodiments may also be implemented as a program or the like recorded on a computer-readable medium for execution by a computer. The computer-readable medium may be a non-transitory computer-readable storage medium, such as a data storage device, that can store data readable by a processor or microprocessor.

Examples of the computer-readable medium may include a hard disk drive (HDD), a solid state drive (SSD), a silicon disk drive (SDD), a read-only memory (ROM), a CD-ROM, a magnetic tape, a floppy disk, and an optical data storage device.

According to the embodiments of the present disclosure as described above, by dynamically adjusting a matching threshold value according to a confidence score of a detected object and processing the detected objects in a single matching step without dividing them based on their confidence scores, it is possible to solve the problem in which conventional cascade matching methods may ignore low-confidence detected objects corresponding to true positives.

Furthermore, according to the embodiments of the present disclosure, by suppressing the matching of low-confidence detected objects corresponding to false positives and preserving the matching of low-confidence detected objects close to true positives, a remarkable effect may also be achieved in that matching accuracy is improved, thereby enabling more robust trajectory generation of tracked objects.

The above description of the present disclosure is for illustrative purposes, and those skilled in the art may understand that it can be easily modified into other specific forms without changing the technical spirit or essential features of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the above detailed description, and all changes or modifications derived from the meaning and scope of the claims and equivalent concepts should be interpreted to be included in the scope of the present disclosure.

### EXPLANATION OF REFERENCE

100: Unified matching system for multi-pedestrian tracking
110: Sensor
111: Front camera
112: Rear camera
113: Font radar
114: Corner radar
120: Controller
121: Processor
130: Braking apparatus
140: Steering apparatus
150: Warning apparatus

1. A unified matching method for multi-pedestrian tracking, the method comprising:
dividing road environment images collected from at least one sensor into frames and detecting an object in an N-th frame;
calculating a matching cost matrix between the detected object and tracked objects detected in a previous frame of the road environment images;
matching the detected object with one of the tracked objects using the matching cost matrix;
generating a matching threshold value based on a confidence score of the detected object;
updating the matched tracked object using the detected object when a matching cost between the matched tracked object and the detected object is smaller than the matching threshold value; and
controlling a vehicle based on the updated tracked object.

2. The unified matching method of claim 1, wherein the generating of the matching threshold value comprises:
determining the confidence score of the detected object; and
generating the matching threshold value by multiplying the confidence score with a predetermined threshold constant value.

3. The unified matching method of claim 2, wherein the generating of the matching threshold value further comprises generating a matching threshold matrix including matching threshold values, and
wherein if the number of the tracked objects is n and the number of detected objects is m, a dimension of the matching threshold matrix is (n, m).

4. The unified matching method of claim 1, wherein the calculating of the matching cost matrix comprises:
predicting expected positions of the tracked objects in the N-th frame by using a Kalman filter; and
calculating the matching cost matrix based on Intersection over Union (IoU) values between bounding boxes of the tracked objects at the expected positions and a bounding box of the detected object.

5. The unified matching method of claim 4, wherein the calculating of the matching cost matrix further comprises:
calculating embedding vectors of the tracked objects by inputting regions of the bounding boxes of the tracked objects into a feature extractor;
calculating an embedding vector of the detected object by inputting a region of the bounding box of the detected object into the feature extractor; and
calculating the matching cost matrix based on cosine distances between the embedding vectors of the tracked objects and the embedding vector of the detected object.

6. The unified matching method of claim 1, wherein the matching of the detected object with one of the tracked objects comprises:
performing one-to-one matching between the detected object and the tracked objects by using a Hungarian algorithm.

7. The unified matching method of claim 1, wherein if the confidence score of the detected object is greater than or equal to a predetermined threshold value and the detected object is not matched with any one of the tracked objects, a new tracked object is generated by using the detected object.

8. The unified matching method of claim 7, wherein the new tracked object is deleted when the new tracked object is not matched with an object detected in a subsequent frame.

9. The unified matching method of claim 7, wherein the new tracked object becomes a confirmed tracked object when the new tracked object is subsequently matched for at least a predetermined number of consecutive frames, and the confirmed tracked object is not deleted even if it is not matched with an object detected in a subsequent frame.

10. A unified matching system for multi-pedestrian tracking, comprising:
a controller comprising at least one processor configured to control a vehicle based on information on road environment images of a road on which the vehicle travels,
wherein the controller is configured to: divide the road environment images into frames; detect an object in an N-th frame; calculate a matching cost matrix between the detected object and tracked objects detected in a previous frame of the road environment images; match the detected object with one of the tracked objects by using the matching cost matrix; generate a matching threshold value based on a confidence score of the detected object; update the matched tracked object using the detected object when a matching cost between the matched tracked object and the detected object is smaller than the matching threshold value; and control the vehicle based on the updated tracked object.

11. The unified matching system of claim 10, wherein the controller is connected to a braking apparatus configured to control a longitudinal driving of the vehicle and a steering apparatus configured to control a lateral driving of the vehicle, and
the controller is configured to control at least one of the braking apparatus and the steering apparatus based on the updated tracked object.

12. The unified matching system of claim 10, wherein the information on the road environment images is collected by a sensor, and the sensor comprises at least one of a front camera and a rear camera.

13. The unified matching system of claim 10, wherein the controller is configured to determine the confidence score of the detected object and generate the matching threshold value by multiplying the confidence score with a predetermined threshold constant value.

14. The unified matching system of claim 13, wherein the controller is configured to generate a matching threshold matrix including matching threshold values, and
if the number of tracked objects is n and the number of detected objects is m, a dimension of the matching threshold matrix is (n, m).

15. The unified matching system of claim 14, wherein the controller is configured to: predict expected positions of the tracked objects in the N-th frame by using a Kalman filter; and calculate the matching cost matrix based on Intersection over Union (IoU) values between bounding boxes of the tracked objects at the expected positions and a bounding box of the detected object.

16. The unified matching system of claim 15, wherein the controller is configured to: calculate embedding vectors of the tracked objects by inputting regions of the bounding boxes of the tracked objects into a feature extractor; calculate an embedding vector of the detected object by inputting a region of the bounding box of the detected object into the feature extractor; and calculate the matching cost matrix based on cosine distances between the embedding vectors of the tracked objects and the embedding vector of the detected object.

17. The unified matching system of claim 16, wherein the controller is configured to perform one-to-one matching between the detected object and the tracked objects by using a Hungarian algorithm.

18. The unified matching system of claim 17, wherein the controller is configured to generate a new tracked object using the detected object when the confidence score of the detected object is greater than or equal to a predetermined threshold and the detected object is not matched with any one of the tracked objects.

19. The unified matching system of claim 18, wherein the controller is configured to delete the new tracked object when the new tracked object is not matched with an object detected in a subsequent frame, determine the new tracked object as a confirmed tracked object when the new tracked object is subsequently matched for at least a predetermined number of consecutive frames, and the confirmed tracked object is not deleted even if the confirmed tracked object is not matched with an object detected in a subsequent frame.

20. A non-transitory computer-readable recording medium that records a program for executing a unified matching method for multi-pedestrian tracking on a computer, the method comprising:
dividing road environment images collected from at least one sensor into frames and detecting an object in an N-th frame;
calculating a matching cost matrix between the detected object and tracked objects detected in a previous frame of the road environment images;
matching the detected object with one of the tracked objects using the matching cost matrix;
generating a matching threshold value based on a confidence score of the detected object;
updating the matched tracked object using the detected object when a matching cost between the matched tracked object and the detected object is smaller than the matching threshold value; and
controlling a vehicle based on the updated tracked object.
